(19) United States
(12) Patent Application Publication
(10) Pub. No.: US 2003/0091174 A1
(43) Pub. Date: May 15, 2003

(54) Phone your own home from within

(76) Inventors: Edward Fulford, Boise, ID (US); Kathryn E. Fulford, Boise, ID (US)

Correspondence Address: HEWLETT-PACKARD COMPANY, Intellectual Property Administation, P.O. Box 272400, Fort Collins, CO, 80527-2400, US

(21) Appl. No.: 09/986,870

(22) Filed: Nov. 13, 2001

(51) Int. Cl. H04M 1/60; H04M 9/00

(52) U.S. Cl. 379/167.11; 379/167.01

(57) ABSTRACT

A home telephone system uses one or more super mini-private branch exchange (PBX) devices that enable telephone units on a same internal phone line to ring each other without involving a central office. After identifying a call as an internal call, the super mini-PBX devices may ring all other telephone units within the home. Alternatively, the home telephone system may assign different numerical numbers and/or ring styles to specific telephone units so that a specific telephone unit may be reached directly by dialing an assigned number from one of the telephone units within the home. When only one super mini-PBX exists, the home telephone system may assign different ring styles to reach a particular telephone unit. The home telephone system uses existing telephone equipment without the need of special wiring, thus improving in-home communication without the complexity or additional cost associated with intercom systems. In addition, the home telephone system affords private conversation within the home.

### TECHNICAL FIELD

The technical field relates to telephone systems, and, in particular, to home telephone systems.

### BACKGROUND

Telephone technology has advanced in recent years, especially in commercial settings. However, home telephone operation still faces many inconveniences. For example, in a typical home with two or three stories, a person often has to walk up or down a couple of flights of stairs to ask a simple question or to exchange a few words with another family member.

Some families install intercom systems to ease the communication within the home. However, older intercom systems often require the use of separate interconnecting lines that must be installed between separate telephone units. In addition, older intercom systems generally require separate wiring and complex circuitry, including alternating current power sources. Installing additional hardware and special wirings in existing structures is complex, time consuming, and costly. Newer wireless intercom systems may be less costly and more convenient. However, users need to purchase additional hardware. In addition, intercom systems typically offer a public open method for communication, where either side of the conversation can be easily heard by others. Users who prefer to keep conversations private may find intercom systems useless.

### SUMMARY

A home telephone system includes a plurality of telephone units installed inside a home, and one or more super mini-private branch exchange (PBX) devices. The super mini-PBX device may include a liquid crystal display (LCD) readout panel capable of configuring the super mini-PBX device, and one or more RJ11 interfaces capable of connecting the super mini-PBX device to one of the plurality of telephone units and a wall jack. The one or more super mini-PBX devices identify and filter calls made within the home so that one telephone unit can call other telephone units through the one or more super mini-PBX devices.

A first embodiment of the home telephone system has one super mini-PBX device attached to each telephone unit, whereas a second embodiment of the home telephone system has only one super mini-PBX device attached to one of the plurality of telephone units. A third embodiment of the home telephone system uses a wireless super mini-PBX device and a base station that functions as a super mini-PBX device.

The home telephone system uses existing telephone equipment without the need of special wiring. In addition, the home telephone system affords private conversation within the home.

### DESCRIPTION OF THE DRAWINGS

The preferred embodiments of the home telephone system will be described in detail with reference to the following figures, in which like numerals refer to like elements, and wherein:

FIG. 1 illustrates a typical telephone system;

FIG. 2A illustrates a first embodiment of a home telephone system;

FIG. 2B illustrates a second embodiment of the home telephone system;

FIG. 3 illustrates a super mini-private branch exchange (PBX) device that may be used in the home telephone system of FIGS. 2A and 2B;

FIG. 4 illustrates a third embodiment of the home telephone system, which uses a wireless super mini-PBX device;

FIG. 5 illustrates the wireless super mini-PBX device of FIG. 4; and

FIG. 6 is a flow chart illustrating a method for phoning an own home from within.

### DETAILED DESCRIPTION

A home telephone system uses one or more super mini-private branch exchange (PBX) devices that enable telephone units on a same internal phone line to ring each other without involving a central office. After identifying a call as an internal call, the super mini-PBX devices may ring all other telephone units within the home. Alternatively, the home telephone system may assign different numerical numbers and/or ring styles to specific telephone units so that a specific telephone unit may be reached directly by dialing an assigned number from one of the telephone units within the home. When only one super mini-PBX exists, the home telephone system may assign different ring styles to reach a particular telephone unit. The home telephone system uses existing telephone equipment without the need of special wiring, thus improving in-home communication without the complexity or additional cost associated with intercom systems. In addition, the home telephone system affords private conversation within the home. For example, if parents are hosting a party downstairs, a child who has an embarrassing question may simply call downstairs without interrupting the party or letting others know of the problem.

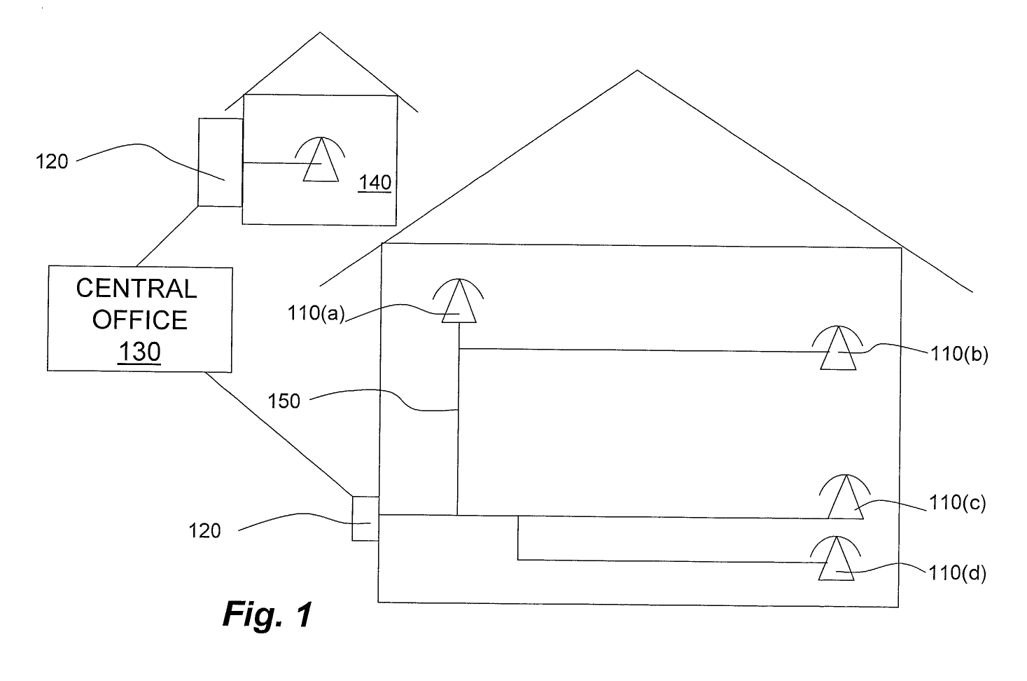

FIG. 1 illustrates a typical telephone system. A local exchange carriers (LEC) central office 130 typically connects telephone lines from telephone units 110(a), 110(b), 110(c), 110(d) within a home to an outside telephone unit 140 through a demarcation (demarc) point 120. The demarc point 120 is typically the interface point between home telephone lines and LEC lines. One line 150 per telephone number typically connects the demarc point 120 to the central office 130, where general switching typically occurs. The telephone units 110(a), 110(b), 110(c), 110(d) are typically connected inside the home to the same telephone line 150, which may be spliced many times within the home.

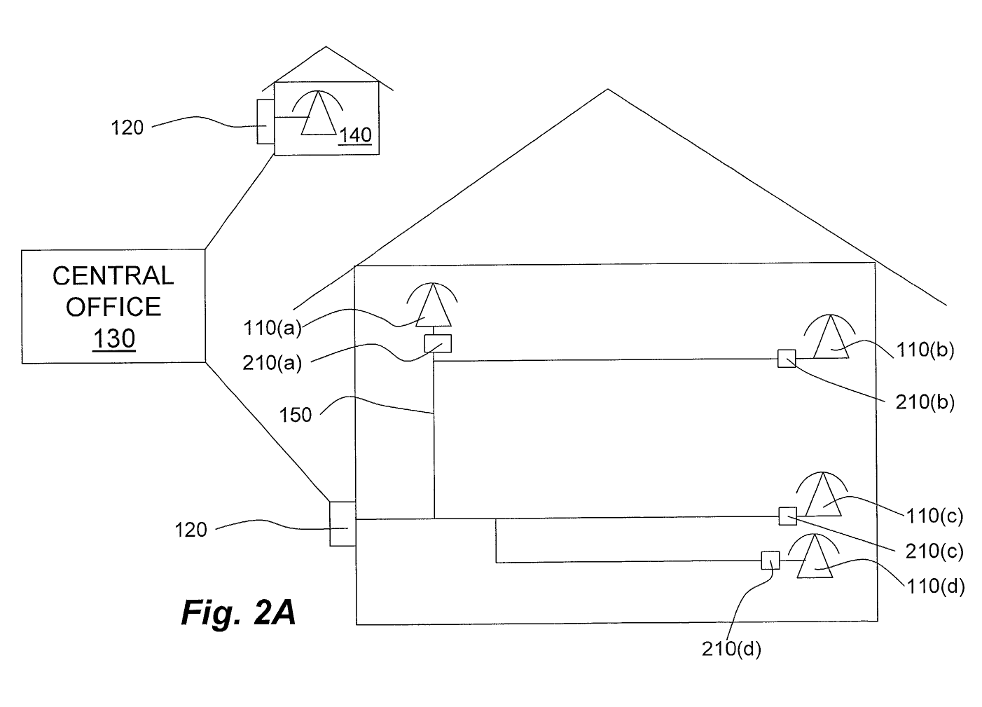

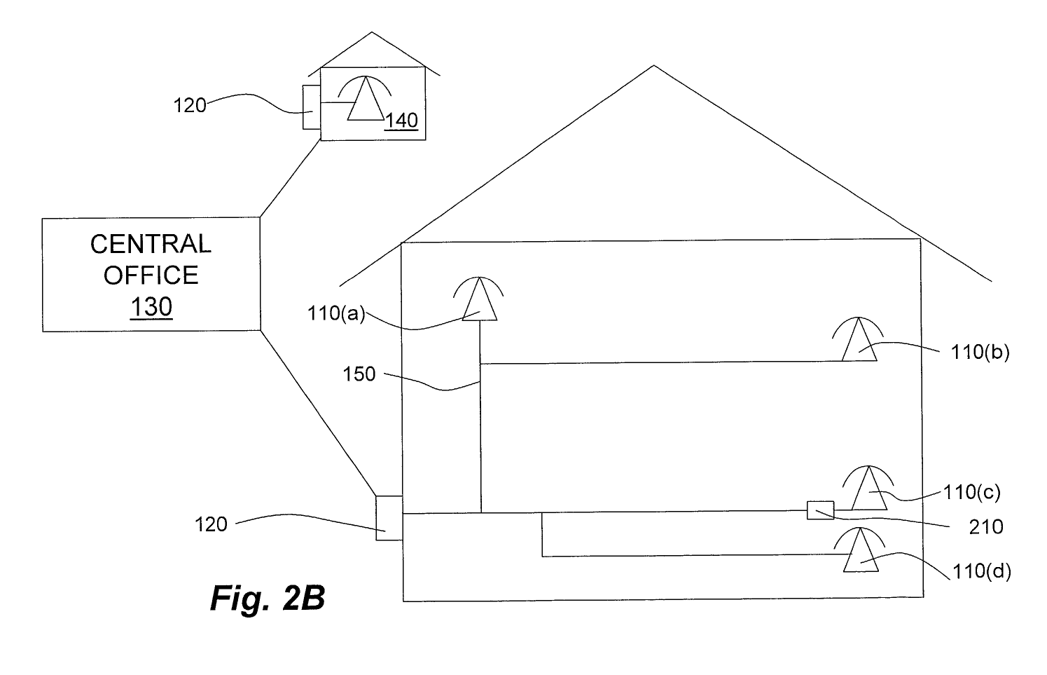

FIG. 2A illustrates a first embodiment of an exemplary home telephone system. In this embodiment, the home telephone system has one super mini-PBX device 210(a), 210(b), 210(c), 210(d) attached to each telephone unit 110(a), 110(b), 110(c), 110(d), respectively. The super mini-PBX devices 210(a), 210(b), 210(c), 210(d) may be configured to recognize its own home number, thus filtering internal calls from external calls. External calls may be forwarded to the central office 130, whereas internal calls may be sent to one or more other telephone units 110(a), 110(b), 110(c), 110(d) within the home without involving the central office 130. For example, when the own home number is dialed from, for example, a telephone unit 110(a), the super mini-PBX device 210(a) attached to that telephone unit 110(a) may send a packet and ring voltage down the telephone line 150 to ring all other telephone units 110(b), 110(c), 110(d) connected on the telephone line 150. Ringing all the telephone units 110(a), 110(b), 110(c), 110(d) may be especially useful when a family member cannot be located. As soon as any one of the telephone units 110(a), 110(b), 110(c), 110(d) is answered, the ring stops. Ring tones associated with internal calls may be programmed as different from ring tones associated with calls made from outside.

Alternatively, the telephone units within the home may be assigned different numerical numbers and/or ring styles, and the super mini-PBX devices 210(a), 210(b), 210(c), 210(d) may send different ring styles to different telephone units 110(a), 110(b), 110(c), 110(d). Accordingly, a user may dial a specific telephone unit by dialing a specific numerical number, and only that telephone unit rings. For example, #1 may be assigned for kitchen (telephone unit 110(c)), #2 for basement (telephone unit 110(d)), #3 for master bedroom (telephone unit 110(a)), and #4 for guest room (telephone unit 110(b)). If a user dials “#2” from a telephone unit 110(c) in the kitchen, the attached super mini-PBS device 210(c) may automatically send a #2 ring style down the telephone line 150, so that only the telephone unit 110(d) in the basement rings.

A special number, such as “9,” may be assigned to the outside lines. When the pre-assigned special number is dialed from, for example, the telephone unit 110(a), the attached super mini-PBX devices 210(a), may automatically bypass a local ringer and switch the call to the central office 130. After a regular dial tone is heard, an outside number may be dialed. Switching techniques are well known in the art.

FIG. 2B illustrates a second embodiment of the exemplary home telephone system. In this embodiment, the home telephone system has one super mini-PBX device 210 attached to one of the telephone units 110(c). Once an internal call is placed from one of the telephone units, for example, 110(c), all other telephone units 110(a), 110(b), 110(d) may ring. Because the other telephone units 110(a), 110(b), 110(d) do not have super mini-PBX devices attached, the other telephone units 110(a), 110(b), 110(d) typically ring automatically with a special ring style or pattern to demonstrate that the call is an internal call. Alternatively, the user may control ring styles so that a specific telephone unit can be reached directly, as described above. For example, if a user dials “#2” from a telephone unit 110(c) in the kitchen, the attached super mini-PBS device 210(c) may automatically send a #2 ring style down the telephone line 150, so that all the telephone units ring, but only the telephone unit 110(d) in the basement should be answered.

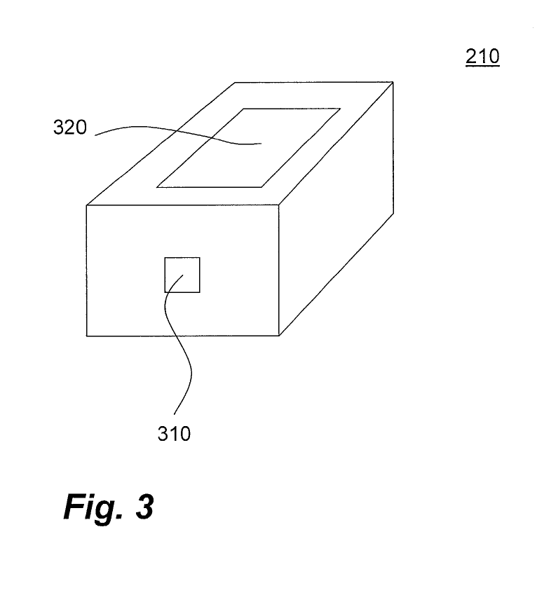

FIG. 3 illustrates an exemplary super mini-PBX device 210 that may be used in the first and second embodiments of the exemplary home telephone system. The exemplary super mini-PBX device 210 typically has a liquid crystal display (LCD) readout 320 located on top of the device 210. A user may configure the super mini-PBX device 210 through the LCD readout 320 in order to, for example, assign numerical numbers or ring styles. The user may use telephone handset number pads for configuration, with a menu displayed on the LCD readout 320. The exemplary super mini-PBX device 210 typically includes two RJ11 interfaces 310 capable of connecting the super mini-PBX device 210 to an existing telephone unit 110(a), 110(b), 110(c), 110(d) and a wall jack. The two RJ11 interface 310 may be located on either side of the device 210.

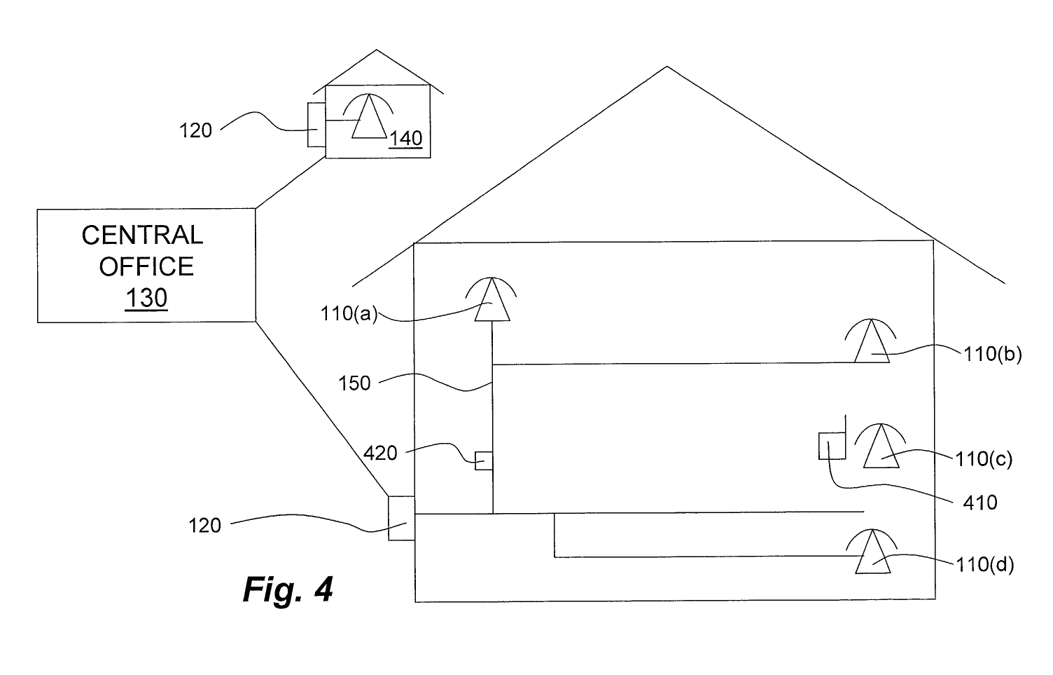

FIG. 4 illustrates a third embodiment of the exemplary home telephone system, which uses a wireless super mini-PBX device 410. In this embodiment, the home telephone system typically has a base station 420 that is attached to the telephone line 150. The base station 420 typically functions as a normal super mini-PBX 210. The base station 420 typically controls ring voltage and ring styles whenever the super mini-PBX device 410 passes information to the base station 420. Once an internal call is broadcasted from, for example, the telephone unit 110(a), all other telephone units 110(b), 110(c), 110(d) may ring. Alternatively, the base station 420 may differentiate the ring styles and ring a particular telephone unit.

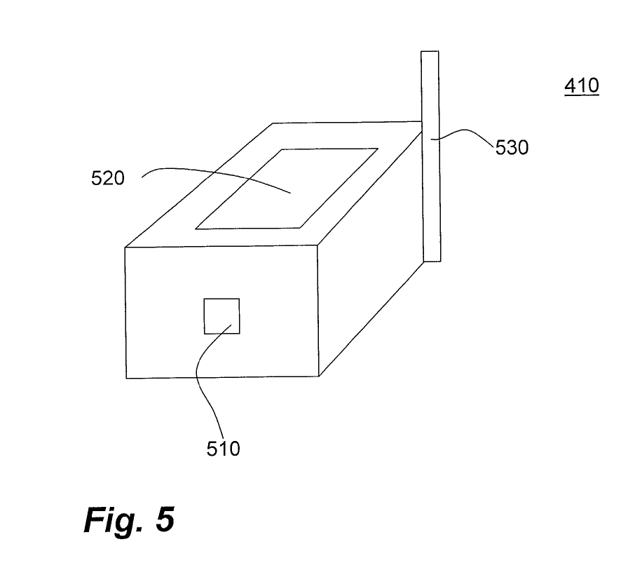

FIG. 5 illustrates the exemplary wireless super mini-PBX device 410 that may be used in the third embodiment of the home telephone system. In addition to a LCD readout 520 and a RJ11 interface 510, the wireless super mini-PBX device 410 may include a wireless antenna 530 for transmitting information to and from the base unit 420.

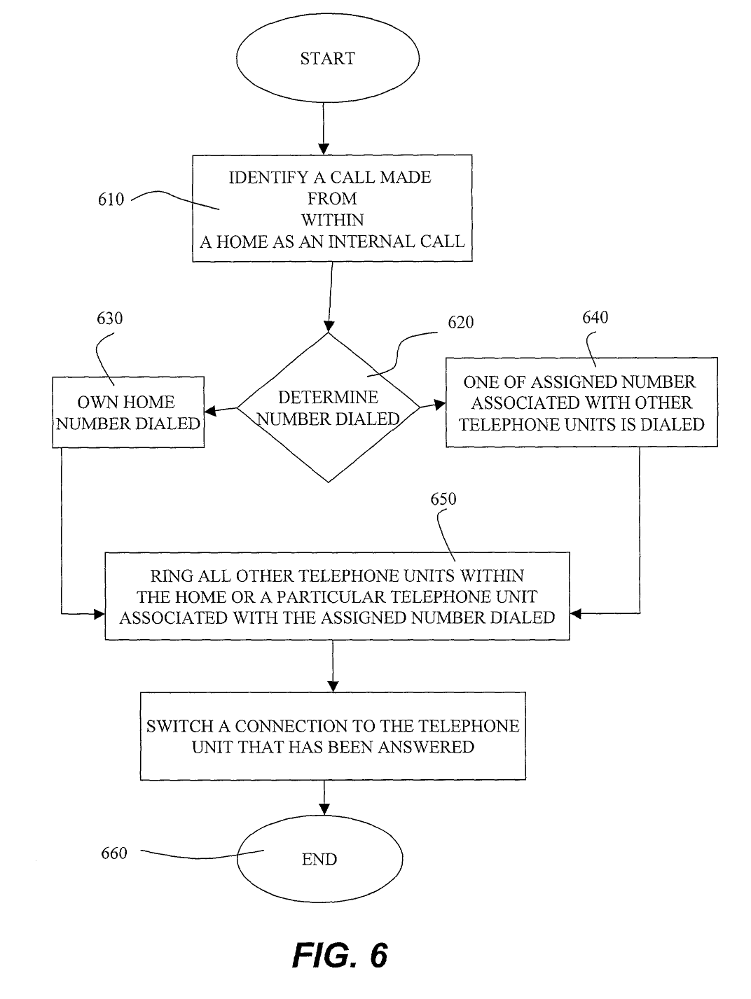

FIG. 6 is a flow chart illustrating an exemplary method for phoning an own home from within using the exemplary home telephone system. The home telephone system first identifies a call made from one of a plurality of telephone units 110(a), 110(b), 110(c), 110(d) within a home as an internal call (block 610), by determining the number dialed (block 620). The internal call may be identified if the own home number is dialed (block 630) or one of assigned numbers associated with other telephone units 110(a), 110(b), 110(c), 110(d) is dialed from within the home (block 640). The home telephone system then rings all other telephone units 110(a), 110(b), 110(c), 110(d) within the home or a particular telephone unit (block 650). After one of the telephone unit is answered, the home telephone system switches a connection to the telephone unit that has been answered, and the ring stops (block 660).

While the home telephone system has been described in connection with an exemplary embodiment, those skilled in the art will understand that many modifications in light of these teachings are possible, and this application is intended to cover any variations thereof.

What is claimed is:

1. A home telephone system, comprising:
a plurality of telephone units installed inside a home; and
one or more super mini-private branch exchange (PBX) devices, wherein one of the one or more super mini-PBX devices comprises:
a liquid crystal display (LCD) readout panel capable of configuring the super mini-PBX device, and
one or more interfaces capable of connecting the super mini-PBX device to one of the plurality of telephone units and a wall jack,
wherein the one or more super mini-PBX devices identify and filter calls made within the home, where one telephone unit can call other telephone units through the one or more super mini-PBX devices.

2. The home telephone system of claim 1, wherein the plurality of telephone units share a same telephone line.

3. The home telephone system of claim 1, wherein each telephone unit has one super mini-PBX device attached.

4. The home telephone system of claim 1, wherein only one super mini-PBX device is attached to one of the plurality of telephone units.

5. The home telephone system of claim 1, wherein if an own home number is dialed from one of the plurality of telephone units, the attached super mini-PBX device rings all other telephone units.

6. The home telephone system of claim 5, wherein if one of the other telephone units is answered, the attached super mini-PBX device switches a connection to the telephone unit that has been answered.

7. The home telephone system of claim 1, wherein the plurality of telephone units are assigned numbers and ring styles, and one telephone unit can call another telephone unit by dialing the assigned number and sending the assigned ring style corresponding to the other telephone unit.

8. The home telephone system of claim 1, wherein the plurality of telephone units can be connected to the one or more outside lines by dialing a pre-assigned number.

9. The home telephone system of claim 8, wherein the pre-assigned number is 9.

10. The home telephone system of claim 1, wherein ring tones associated with the calls made within the home are different from ring tones associated with calls from outside.

11. A home telephone system, comprising:
a plurality of telephone units installed inside a home;
a wireless super mini-private branch exchange (PBX) device, comprising:
a liquid crystal display (LCD) readout panel capable of configuring the super mini-PBX device;
an interface capable of connecting the super mini-PBX device to one of the plurality of telephone; and
a wireless antenna capable of transmitting information to and from the wireless super mini-PBX,
wherein the wireless super mini-PBX device identifies and filters calls made within the home, where one telephone unit can call other telephone units through the wireless super mini-PBX device.

12. The home telephone system of claim 11, wherein the plurality of telephone units share a same telephone line.

13. The home telephone system of claim 12, further comprising a base station that is connected to the telephone line, wherein the base station functions as a super mini-PBX device.

14. The home telephone system of claim 11, wherein if an own home number is dialed from one of the plurality of telephone units, the wireless super mini-PBX device rings other telephone units.

15. The home telephone system of claim 11, wherein the plurality of telephone units are assigned numbers, and one telephone unit can call another telephone unit by dialing the assigned number corresponding to the other telephone unit.

15. The home telephone system of claim 11, wherein the plurality of telephone units are assigned numbers and ring styles, and one telephone unit can call another telephone unit by dialing the assigned number and sending the assigned ring style corresponding to the other telephone unit.

16. The home telephone system of claim 11, wherein the plurality of telephone units can be connected to the one or more outside lines by dialing a pre-assigned number.

17. A method for calling an own home from within, comprising:
identifying a call made from one of a plurality of telephone units within a home as an internal call;
ringing other telephone units within the home; and
switching a connection to one of the other telephone units that has been answered.

18. The method of claim 17, wherein the identifying step includes determining if an own home number is dialed from the one of the plurality of telephone units within the home.

19. The method of claim 17, wherein the identifying step includes determining if one of assigned numbers associated with the plurality of telephone units is dialed from within the home.

20. The method of claim 19, wherein the ringing step includes ringing one of the other telephone units whose assigned number has been dialed.
